(19) United States
(12) Patent Application Publication
(10) Pub. No.: US 2005/0162133 A1
(43) Pub. Date: Jul. 28, 2005

(54) Low cost charger connections manufactured from conductive loaded resin-based material

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 11/089,292

(22) Filed: Mar. 24, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/561,756, filed on Apr. 13, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. H01M 2/00

(52) U.S. Cl. 320/128

(57) ABSTRACT

Battery charger terminals formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non- metal, plated, or in combination with, metal powders. The micron conductor fibers preferably are of nickel plated carbon fiber, stainless steel fiber, copper fiber, silver fiber, aluminum fiber, or the like.

This Patent Application claims priority to the U.S. Provisional Patent Application 60/561,756 filed on Apr. 13, 2004, which is herein incorporated by reference in its entirety.

This Patent Application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Application Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to charger connections and, more particularly, to battery charger connections molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

Portable electrical and electronic devices are widely used in industrial and consumer applications. A common feature in most of these portable devices is a battery power source. Battery power sources comprise a means of storing energy in chemical form and releasing this energy as electrical power upon demand from the portable device. In a typical battery source, a set of dissimilar elemental electrodes are held in an electrolyte. When an electrical demand is placed across the electrodes, an internal electrochemical reaction occurs between the electrodes and the electrolyte. This electrochemical reaction generates free electrons at a voltage potential as a by-product.

In most cases, it is assumed that the battery, even if it is rechargeable, is a replaceable component of the portable electrical or electronics system. Therefore, the battery must be designed for handling and for replacement. In many cases, the electrode materials that are used in the electrochemical reaction are not appropriate for external use because the material is expensive, hazardous, and/or does not have optimal properties of hardness or electrical conductivity. For example, lead metal may be used as both the inner electrode and the outer terminal in a lead-acid battery such as is commonly found in motor vehicle applications. However, in various portable batteries, such as dry cell batteries, the external contact terminals for the batteries are typically formed of very conductive metals that contact internal electrodes, of differing material composition, either directly or via a conductive paste.

A typical problem for various types of batteries is that of corrosion. The corrosive chemical conditions that cause reactions to occur at the internal electrodes also present a corrosive environment for the external electrodes. In addition, external environmental conditions of portable operation tend to increase corrosive. In a motor vehicle, for example, external conditions of moisture, road and sea salt, and vehicle fluids, combine with the inherent voltage conditions to cause rapid electro-voltaic corrosion of the battery electrodes and cables. Corrosion of these components causes many reliability concerns. A key objective of the present invention is to provide external battery charger terminals, contacts, and conductors combining excellent electrical performance with excellent corrosion resistance.

Several prior art inventions relate to battery charger connections. U.S. Patent Application 2003/0136947 to Matsumora et al describes a conductive resin composition including powdered silver and/or fine fibers of inorganic compound in a resin base. Contact terminals or electrodes are formed by applying a paint layer of the conductive resin to a substrate. U.S. Pat. No. 4,838,799 to Tonooka teaches an IC socket having contacts partially comprising a conductive resin. The conductive resin comprises a resin or plastic and a conductive material, such as metal powder or fiber. U.S. Patent Application 2002/0005569 to Kobayashi et al describes contact terminals for a probing apparatus used in measuring electrical characteristics of a semiconductor device. The contact terminals comprise conductive resin or rubber. U.S. Patent Application 2001/0002787 to Hyogo describes an inductive charging coupling paddle. Conductive resin materials are used as inner covers in the paddle assembly.

### SUMMARY OF THE INVENTION

A principal object of the present invention is to provide an effective battery charger contact point and charging circuits.

A further object of the present invention is to provide a method to form battery charger connections.

A further object is to form battery connections that are non-corrosive.

A further object of the present invention is to provide battery charger connections molded of conductive loaded resin-based materials.

A yet further object of the present invention is to provide battery charger connections molded of conductive loaded resin-based material where the connection characteristics can be altered or the visual characteristics can be altered by forming a metal layer over the conductive loaded resin-based material.

A yet further object of the present invention is to provide methods to fabricate battery charger connections from a conductive loaded resin-based material incorporating various forms of the material.

In accordance with the objects of this invention, a battery charging device is achieved. The device comprises a power source capable of converting an AC voltage into a DC voltage. A first terminal is coupled to a first polarity of the DC voltage. A second terminal is coupled to a second polarity of the DC voltage. The first and second terminals comprise a conductive loaded, resin-based material comprising conductive materials in a base resin host.

Also in accordance with the objects of this invention, a battery charging device is achieved. The device comprises a power source capable of converting an AC voltage into a DC voltage. A first terminal is coupled to a first polarity of the DC voltage. A second terminal is coupled to a second polarity of the DC voltage. The first and second terminals comprise a conductive loaded, resin-based material comprising conductive materials in a base resin host. The percent by weight of the conductive materials is between 20% and 40% of the total weight of the conductive loaded resin-based material.

Also in accordance with the objects of this invention, a battery charging device is achieved. The device comprises a power source capable of converting an AC voltage into a DC voltage. A first terminal is coupled to a first polarity of the DC voltage. A second terminal is coupled to a second polarity of the DC voltage. The first and second terminals comprise a conductive loaded, resin-based material comprising micron conductive fiber in a base resin host. The percent by weight of the micron conductive fiber is between 20% and 40% of the total weight of the conductive loaded resin-based material.

Also in accordance with the objects of this invention, a method to form a battery charging device is achieved. The method comprises providing a power source capable of converting an AC voltage into a DC voltage. A conductive loaded, resin-based material is provided comprising conductive materials in a resin-based host. The conductive loaded, resin-based material is molded into an external terminal. The external terminal is connected to the DC voltage.

Also in accordance with the objects of this invention, a method to form a battery charging device is achieved. The method comprises providing a power source capable of converting an AC voltage into a DC voltage. A conductive loaded, resin-based material comprising conductive materials in a resin-based host is provided. The percent by weight of the conductive materials is between 20% and 40% of the total weight of the conductive loaded resin-based material. The conductive loaded, resin-based material is molded into first and second external terminals. The external terminals are connected to first and second polarities of the DC voltage.

Also in accordance with the objects of this invention, a method to form a battery charging device is achieved. The method comprises providing a power source capable of converting an AC voltage into a DC voltage. A conductive loaded, resin-based material comprising micron conductive fibers in a resin-based host is provided. The percent by weight of the micron conductive fibers is between 20% and 40% of the total weight of the conductive loaded resin-based material. The conductive loaded, resin-based material is molded into first and second external terminals. The external terminals are connected to first and second polarities of the DC voltage.

### BRIEF DESCRIPTION OF THE DRAWINGS

In the accompanying drawings forming a material part of this description, there is shown:

FIG. 1 illustrates a first preferred embodiment of the present invention showing a charger connection a portable telephone and charging station with charger connections comprising a conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold charger connections of a conductive loaded resin-based material.

FIG. 7 illustrates a second preferred embodiment of the present invention showing a automotive or RV battery charger having terminals comprising a conductive loaded resin-based material.

FIGS. 8a and 8b illustrate a third preferred embodiment of the present invention showing a dry cell battery charger having terminals comprising a conductive loaded resin-based material.

FIG. 9 illustrates a fourth preferred embodiment of the present invention showing a camera battery charger having terminals comprising a conductive loaded resin-based material.

FIGS. 10a and 10b illustrate a fifth preferred embodiment of the present invention showing a cellular telephone and battery charger having terminals comprising a conductive loaded resin-based material.

FIGS. 11, 12a, and 12b illustrate a sixth preferred embodiment of the present invention showing a portable power tool having a rechargeable battery pack and a recharging station wherein the recharging station has terminals comprising a conductive loaded resin-based material.

### DESCRIPTION OF THE PREFERRED EMBODIMENTS

This invention relates to charger connections molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of charger connections fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the charger connections are substantially homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of charger connections significantly lowers the cost of materials and the design and manufacturing processes used to hold ease of close tolerances, by forming these materials into desired shapes and sizes. The charger connections can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. The micron conductive powders can be of carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, aluminum fiber, or the like, or combinations thereof. Superconductor metals, such as titanium, nickel, niobium, and zirconium, and alloys of titanium, nickel, niobium, and zirconium may also be used as micron conductive fibers in the present invention. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the charger connections. The doping composition and directionality associated with the micron conductors within the loaded base resins can affect the electrical and structural characteristics of the charger connections and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming charger connections that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in charger connections as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, charger connections manufactured from the molded conductor loaded resin-based material can provide added thermal dissipation capabilities to the application. For example, heat can be dissipated from electrical devices physically and/or electrically connected to charger connections of the present invention.

As a significant advantage of the present invention, charger connections constructed of the conductive loaded resin-based material can be easily interfaced to an electrical circuit or grounded. In one embodiment, a wire can be attached to a conductive loaded resin-based charger connections via a screw that is fastened to the charger connection. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the charger connections and a grounding wire.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary non-ferromagnetic conductor fibers include stainless steel, nickel, copper, silver, aluminum, or other suitable metals or conductive fibers, alloys, plated materials, or combinations thereof. Superconductor metals, such as titanium, nickel, niobium, and zirconium, and alloys of titanium, nickel, niobium, and zirconium may also be used as micron conductive fibers in the present invention. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials.

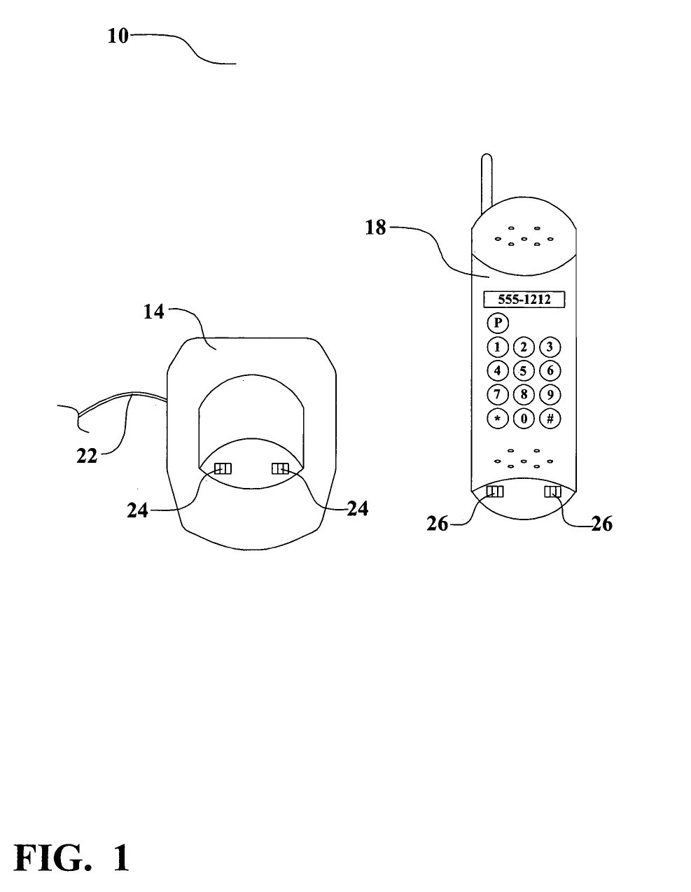

Referring now to FIG. 1 a preferred embodiment of the present invention is illustrated. A battery charger application 10 is shown. Several important features of the present invention are shown and discussed below. A portable telephone 18 and a re-charging station 14 are illustrated. The portable telephone 18 is powered by a re-chargeable battery as is well known in the art. To maintain proper operation, the portable phone 18 must be periodically placed into its re-charging station 14. The recharging station 14 converts alternating current (AC) electrical power into direct current (DC) electrical power using a transformer/converter unit, not shown. This DC power is carried to the re-charging station 14 by an electrical conductor 22. When the portable telephone 18 is placed into the re-charging station 14 the contacting terminals 26 on the base of the telephone 18 are fixably held in direct contact with the contacting terminals 24 of the charging station. In this way, the DC power of the re-charging station 14 is supplied to the re-chargeable battery held inside the portable telephone 18. The re-charging station 14 supplies DC power to the recharge the telephone battery.

In the present invention, the re-charging station 14 has charging connections 24 molded from conductive loaded resin-based material. In addition, the portable telephone 18 also has charging connections 26 molded from conductive loaded resin-based material. In the prior art, these charging connections are formed using a metal such as aluminum, copper, nickel, or some alloy of these metals. There are several disadvantages to this approach however. First, these all-metal connections can be difficult to manufacture. Second, these all-metal connections are prone to problems such as oxidation, corrosion, and electrolysis. These effects can cause poor connectivity and power transfer between the re-charging station 14 and the portable telephone 18. Frequent cleaning of contacts is needed to prevent incomplete charging of the battery. Third, the charging connections cannot be easily incorporated into the telephone design and are typically not pleasing to look at.

In the present invention, by comparison, the charging connections 24 for the re-charging station 14 and the charging connections 26 for the portable telephone 18 comprise conductive loaded resin-based material. This conductive loaded resin-based material provides a highly conductive interface between the re-charging station 14 and the telephone 18. The charging connections of the present invention provide the low resistance benefits of metal connectors with the resin-based properties of elimination of oxidation, corrosion, or electrolysis. In this way, the charging terminals will perform reliably without frequent cleaning. In addition, use of conductive loaded resin-based material allows the charging terminals to be seamlessly integrated into the telephone 18 and/or battery charger 14 design. In fact, the charging connections 24 and 26 can be flush to the surface of the phone 18 or charger 14 or simply a contact point on the molded body or shell of the phone 18 or charger 14. Further the charging connections 24 and 26 may be molded and colored to blend with the coloring of the re-charging station 14 and the telephone 18 and thus appear invisible.

Alternately, the charging connections 24 and 26 may be adhered to internal surfaces of the re-charging station 14 and the telephone 18 to act as plates of coupling capacitors. The re-charging station 14 incorporates circuitry to convert the 60 Hz line current to a higher frequency that is coupled between the recharging station 14 and the telephone 18 through the capacitors formed by the charging connections 24 and 26. The telephone 18 includes circuitry to convert the coupled higher frequency charging currents to a DC current for charging the internal battery.

These advantages of the charging connections 24 and 26 can be extended to any re-chargeable device and its re-charging station. For example, portable tools, toys, cellular phones, beepers, PDAs, portable computers, razors, and many other portable devices can benefit from the application of the present invention.

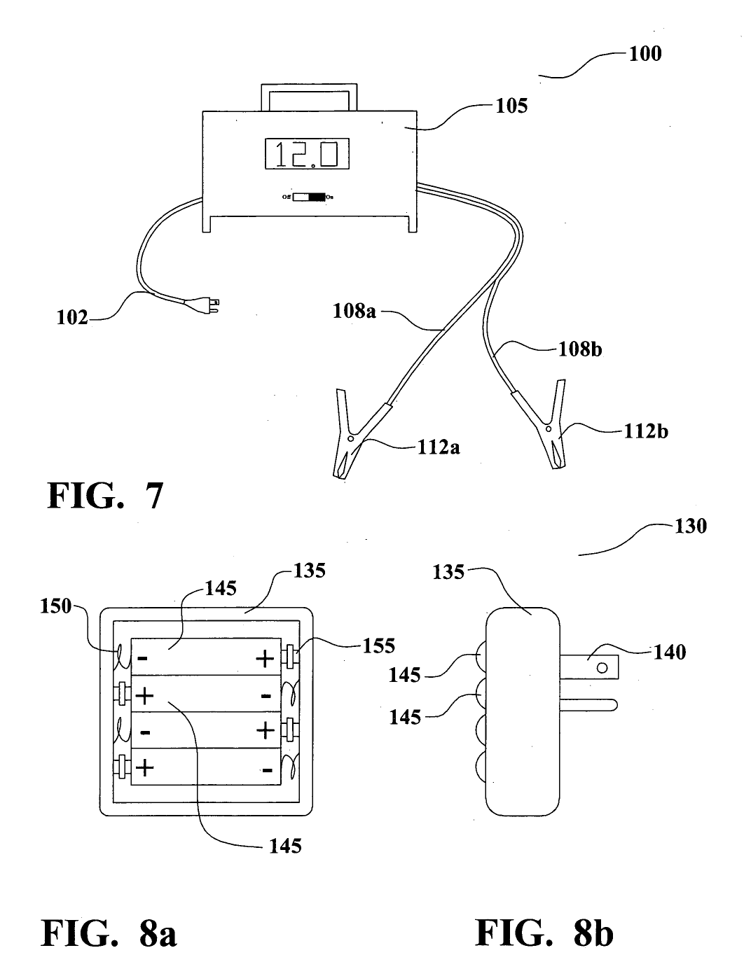

Referring now to FIG. 7 a second preferred embodiment 100 of the present is illustrated. A battery charger 105 for a wet cell, or acid cell, type battery is shown. Wet cell batteries are frequently used in automotive and recreational vehicle (RV) applications. Lead acid batteries, for example, are used to provide a voltage source of, for example, about 12 Volts for a vehicle electrical system. Lead acid batteries are typically rechargeable. The battery charger 105 shown converts alternating current (AC) electrical power into direct current (DC) electrical power using a transformer/converter unit. This AC power is carried to the re-charging station 105 by an electrical conductor 102. The DC power from the charger 105 is supplied to contacting terminals 112a and 112b through terminal cables 108a and 108b.

In the present invention, the re-charging station 105 has charging connectors 112a and 112b molded from conductive loaded resin-based material. These charging connector 112a and 112b can easily be connected to the terminal posts of a typical lead acid battery, not shown. In the prior art, these charging connections are formed using a metal such as aluminum, copper, nickel, or some alloy of these metals. There are several disadvantages to this approach however. First, these all-metal connections can be difficult to manufacture. Second, these all-metal connections are prone to problems such as oxidation, corrosion, and electrolysis. These effects can cause poor connectivity and power transfer between the re-charging station 105 and the battery. Frequent cleaning of contacts is needed to prevent incomplete charging of the battery.

In the present invention, by comparison, the charging connections 112a and 112b and/or the connecting terminals 108a and 108b for the re-charging station 105 comprise the conductive loaded resin-based material of the present invention. This conductive loaded resin-based material provides a highly conductive interface between the re-charging station 105 and the battery. The charging connections of the present invention provide the low resistance benefits of metal connectors with the resin-based properties of elimination of oxidation, corrosion, or electrolysis. In this way, the charging terminals will perform reliably without frequent cleaning. In addition, use of conductive loaded resin-based material allows the charging terminals to be seamlessly integrated into the charger 105. In one embodiment, the charging cables 108a and 108b and/or connectors 112a and 112b are molded into the charger 105.

Referring now to FIGS. 8a and 8b a third preferred embodiment 130 of the present invention is illustrated. A dry cell battery charger 135 is shown. Dry cell batteries 145 are widely used in a variety of consumer applications. The battery charger 135 shown converts alternating current (AC) electrical power into direct current (DC) electrical power using a transformer/converter unit. This AC power is carried to the re-charging station 135 by an electrical plug 140. The DC power from the charger 135 is supplied to contacting terminals 150 and 155.

In the present invention, the re-charging station 135 has charging connectors 150 and 155 molded from conductive loaded resin-based material. The charging connectors 150 and 155 can easily be connected to the terminal posts of a typical lead acid battery, not shown. In the prior art, these charging connections are formed using a metal such as aluminum, copper, nickel, or some alloy of these metals. There are several disadvantages to this approach however. First, these all-metal connections can be difficult to manufacture. Second, these all-metal connections are prone to problems such as oxidation, corrosion, and electrolysis. These effects can cause poor connectivity and power transfer between the re-charging station 135 and the battery. Frequent cleaning of contacts is needed to prevent incomplete charging of the battery.

In the present invention, by comparison, the charging connections 150 and 155 for the re-charging station 135 comprise the conductive loaded resin-based material of the present invention. This conductive loaded resin-based material provides a highly conductive interface between the re-charging station 105 and the battery. The charging connections of the present invention provide the low resistance benefits of metal connectors with the resin-based properties of elimination of oxidation, corrosion, or electrolysis. In this way, the charging terminals will perform reliably without frequent cleaning. In addition, use of conductive loaded resin-based material allows the charging terminals to be seamlessly integrated into the charger 135. In one embodiment, the charging connectors 150 and 155 are molded into the charger 135.

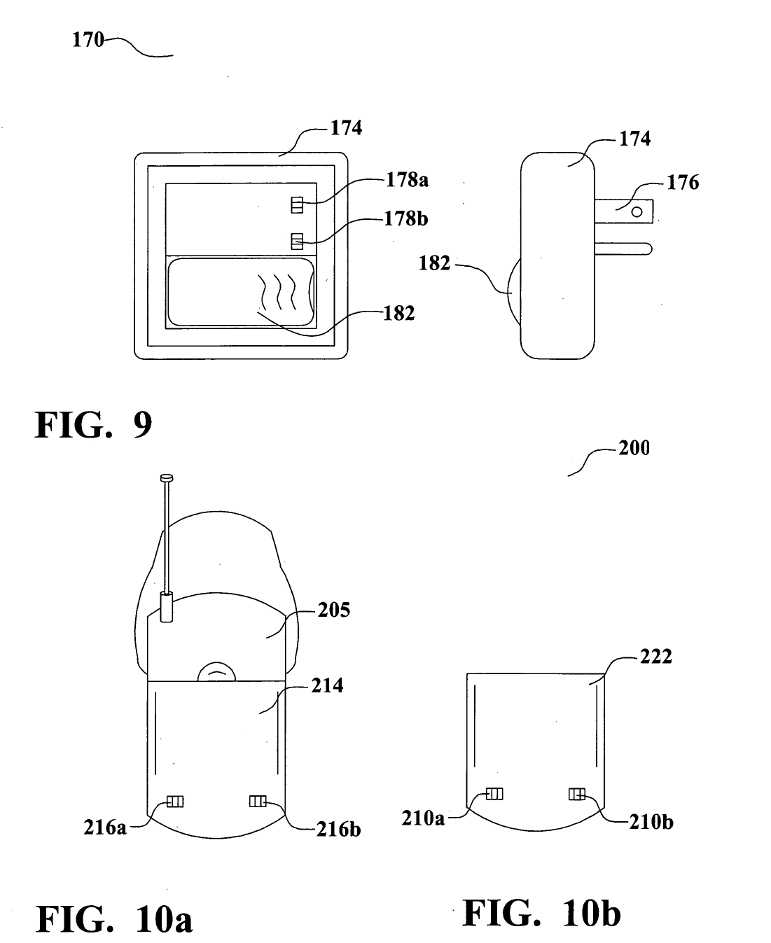

Referring now to FIG. 9 a fourth preferred embodiment 170 of the present invention is illustrated. A camera battery charger 174 is shown. Video and photographic cameras batteries 182 are typically re-chargeable. The camera battery charger 174 shown converts alternating current (AC) electrical power into direct current (DC) electrical power using a transformer/converter unit. This AC power is carried to the re-charging station 174 by an electrical plug 176. The DC power from the charger 174 is supplied to contacting terminals 178a and 178b.

In the present invention, the re-charging station 174 has charging connectors 178a and 178b molded from conductive loaded resin-based material. The charging connector 178a and 178b can easily be connected to the terminal posts of a typical rechargeable camera battery 182. In the prior art, these charging connections are formed using a metal such as aluminum, copper, nickel, or some alloy of these metals. There are several disadvantages to this approach however. First, these all-metal connections can be difficult to manufacture. Second, these all-metal connections are prone to problems such as oxidation, corrosion, and electrolysis. These effects can cause poor connectivity and power transfer between the re-charging station 174 and the battery. Frequent cleaning of contacts is needed to prevent incomplete charging of the battery.

In the present invention, by comparison, the charging connections 178a and 178b for the re-charging station 174 comprise the conductive loaded resin-based material of the present invention. This conductive loaded resin-based material provides a highly conductive interface between the re-charging station 174 and the battery. The charging connections of the present invention provide the low resistance benefits of metal connectors with the resin-based properties of elimination of oxidation, corrosion, or electrolysis. In this way, the charging terminals will perform reliably without frequent cleaning. In addition, use of conductive loaded resin-based material allows the charging terminals to be seamlessly integrated into the charger 174. In one embodiment, the charging connectors 178a and 178b are molded into the charger 174.

Referring now to FIGS. 10a and 10b, a fifth preferred embodiment 200 of the present invention is illustrated. A cellular telephone 205 and battery charger 222 are shown. Electrical terminals 216a and 216b on the battery 214 of the cellular phone 205 and/or electrical terminals 210a and 210b on the charger 222 comprise a conductive loaded resin-based material according to the present invention. Cellular telephones, by nature, rely on portable battery supplies. These batteries 214 are typically re-chargeable. The phone battery charger 222 shown converts alternating current (AC) electrical power into direct current (DC) electrical power using a transformer/converter unit. The DC power from the charger 222 is supplied to contacting terminals 210a and 210b.

In the present invention, the re-charging station 222 has charging connectors 210a and 210b molded from conductive loaded resin-based material. The charging connector 210a and 210b can easily be connected to the terminal posts of the rechargeable phone battery 214. In the prior art, these charging connections are formed using a metal such as aluminum, copper, nickel, or some alloy of these metals. There are several disadvantages to this approach however. First, these all-metal connections can be difficult to manufacture. Second, these all-metal connections are prone to problems such as oxidation, corrosion, and electrolysis. These effects can cause poor connectivity and power transfer between the re-charging station 222 and the battery 214. Frequent cleaning of contacts is needed to prevent incomplete charging of the battery.

In the present invention, by comparison, the charging connections 210a and 210b for the re-charging station 222 comprise the conductive loaded resin-based material of the present invention. This conductive loaded resin-based material provides a highly conductive interface between the re-charging station 222 and the battery 214. The charging connections of the present invention provide the low resistance benefits of metal connectors with the resin-based properties of elimination of oxidation, corrosion, or electrolysis. In this way, the charging terminals will perform reliably without frequent cleaning. In addition, use of conductive loaded resin-based material allows the charging terminals to be seamlessly integrated into the charger 222. In one embodiment, the charging connectors 210a and 210b are molded into the charger 222.

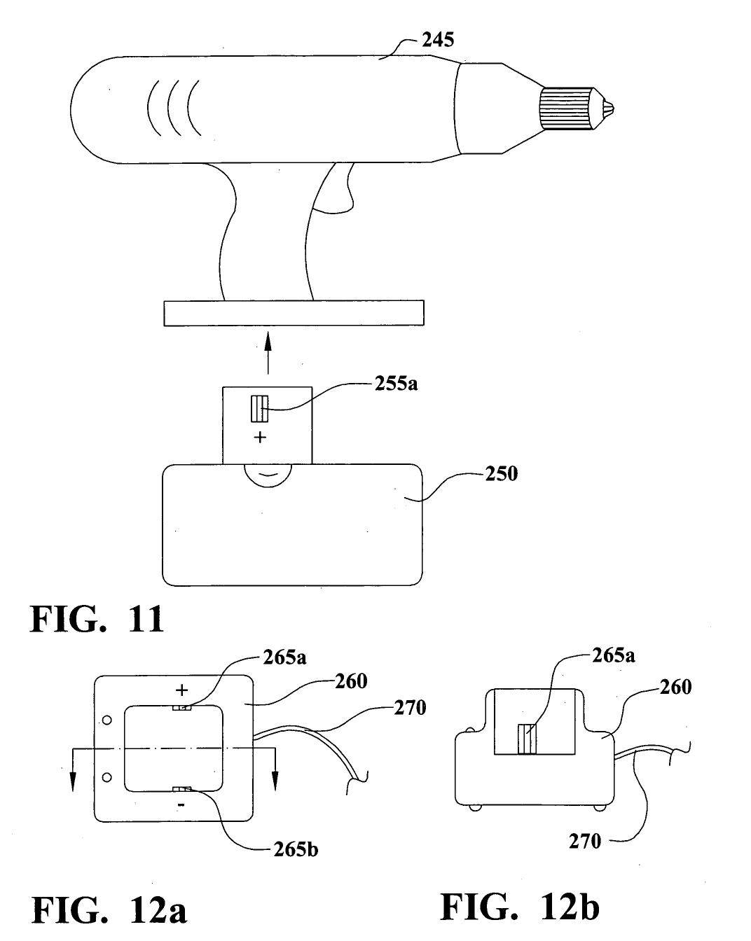

Referring now to FIGS. 11, 12a, and 12b, a sixth preferred embodiment 240 of the present invention is illustrated. A portable power tool 245 having a rechargeable battery pack 250 and a recharging station 260 are shown. The recharging station 260 has terminals 265a and 265b comprising a conductive loaded resin-based material. Portable power tools, such as cordless drills 245, saws, sanders, grinders, flashlights, and the like, frequently rely on portable battery supplies. These batteries 250 are typically re-chargeable. The terminals 255a of the rechargeable battery 250 of the power tool 245 and/or the electrical terminals 265a and 265b of the charger 260 comprise a conductive loaded resin-based material according to the present invention. The battery charger 260 shown converts alternating current (AC) electrical power 270 into direct current (DC) electrical power using a transformer/converter unit. The DC power from the charger 260 is supplied to contacting terminals 265a and 265b. FIG. 12a shown the charging unit 260 in top view, while FIG. 12b shows the charging unit 260 is a side cut-away.

In the present invention, the re-charging station 222 has charging connectors 210a and 210b molded from conductive loaded resin-based material. The charging connector 265a and 265b can easily be connected to the terminal posts, such as the positive post 255a, of the rechargeable battery 250. In the prior art, these charging connections are formed using a metal such as aluminum, copper, nickel, or some alloy of these metals. There are several disadvantages to this approach however. First, these all-metal connections can be difficult to manufacture. Second, these all-metal connections are prone to problems such as oxidation, corrosion, and electrolysis. These effects can cause poor connectivity and power transfer between the re-charging station 260 and the battery 250. Frequent cleaning of contacts is needed to prevent incomplete charging of the battery.

In the present invention, by comparison, the charging connections 265a and 265b for the re-charging station 260 comprise the conductive loaded resin-based material of the present invention. This conductive loaded resin-based material provides a highly conductive interface between the re-charging station 260 and the battery 250. The charging connections of the present invention provide the low resistance benefits of metal connectors with the resin-based properties of elimination of oxidation, corrosion, or electrolysis. In this way, the charging terminals will perform reliably without frequent cleaning. In addition, use of conductive loaded resin-based material allows the charging terminals to be seamlessly integrated into the charger 260. In one embodiment, the charging connectors 265a and 265b are molded into the charger 260.

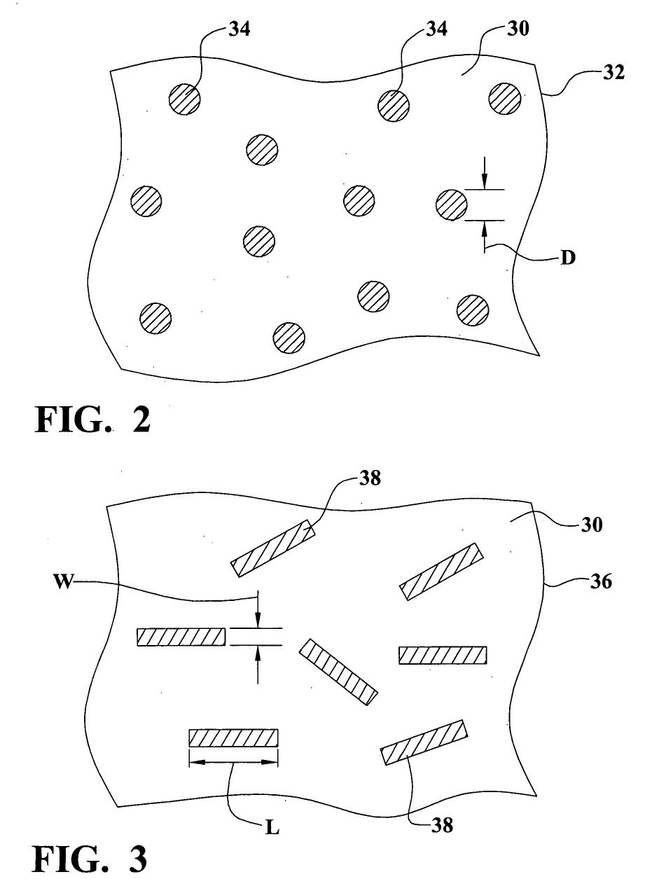

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

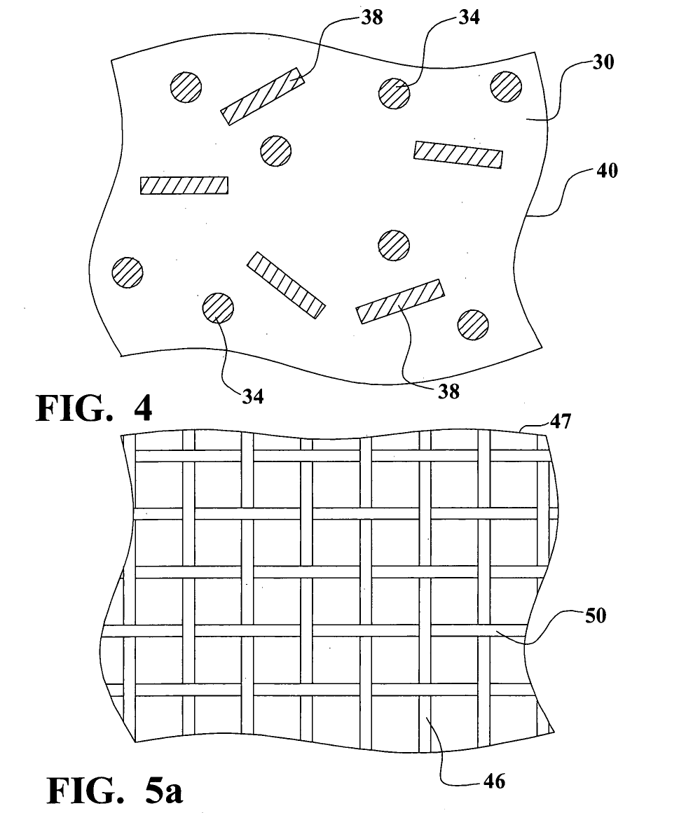

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, aluminum, or other suitable metals or conductive fibers, or combinations thereof. Superconductor metals, such as titanium, nickel, niobium, and zirconium, and alloys of titanium, nickel, niobium, and zirconium may also be used as micron conductive fibers in the present invention. These conductor particles and or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

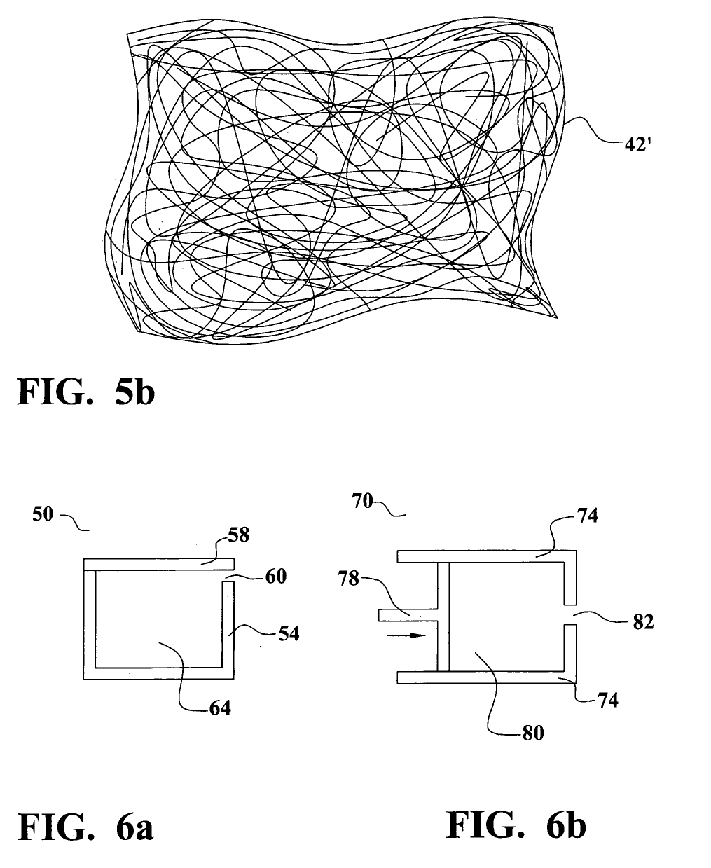

Charger connections formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the charger connections are removed.

FIG. 6b shows a simplified schematic diagram of an extruder 70 for forming charger connections using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective battery charger device is achieved. A method to form battery charger connections is achieved. The battery charger connections are molded of conductive loaded resin-based materials. The connection characteristics can be altered or the visual characteristics can be altered by forming a metal layer over the conductive loaded resin-based material.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A battery charging device comprising:
a power source capable of converting an AC voltage into a DC voltage;
a first terminal coupled to a first polarity of said DC voltage; and
a second terminal coupled to a second polarity of said DC voltage wherein said first and second terminals comprise a conductive loaded, resin-based material comprising conductive materials in a base resin host.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 wherein said conductive materials are non-conductive materials with metal plating.

7. The device according to claim 1 wherein said terminals are molded into the case of said battery charging device.

8. The device according to claim 1 wherein said terminals further comprise ferromagnetic loading.

9. The device according to claim 1 wherein said terminals further comprise a metal layer overlying said conductive loaded resin-based material.

10. A battery charging device comprising:
a power source capable of converting an AC voltage into a DC voltage;
a first terminal coupled to a first polarity of said DC voltage; and
a second terminal coupled to a second polarity of said DC voltage wherein said first and second terminals comprise a conductive loaded, resin-based material comprising conductive materials in a base resin host wherein the percent by weight of said conductive materials is between 20% and 40% of the total weight of said conductive loaded resin-based material.

11. The device according to claim 10 wherein said conductive materials are nickel plated carbon micron fiber, stainless steel micron fiber, copper micron fiber, silver micron fiber or combinations thereof.

12. The device according to claim 10 wherein said conductive materials comprise micron conductive fiber and conductive powder.

13. The device according to claim 12 wherein said conductive powder is nickel, copper, or silver.

14. The device according to claim 12 wherein said conductive powder is a non-conductive material with a metal plating of nickel, copper, silver, or alloys thereof.

15. The device according to claim 10 wherein said terminals are molded into the case of said battery charging device.

16. The device according to claim 10 wherein said terminals further comprise ferromagnetic loading.

17. The device according to claim 10 wherein said terminals further comprise a metal layer overlying said conductive loaded resin-based material.

18. A battery charging device comprising:
a power source capable of converting an AC voltage into a DC voltage;
a first terminal coupled to a first polarity of said DC voltage; and
a second terminal coupled to a second polarity of said DC voltage wherein said first and second terminals comprise a conductive loaded, resin-based material comprising micron conductive fiber in a base resin host wherein the percent by weight of said micron conductive fiber is between 20% and 40% of the total weight of said conductive loaded resin-based material.

19. The device according to claim 18 wherein said micron conductive fiber is stainless steel.

20. The device according to claim 18 wherein said micron conductive fiber has a diameter of between about 3 μm and about 12 μm and a length of between about 2 mm and about 14 mm.
